(19) United States
(12) Patent Application Publication
(10) Pub. No.: US 2013/0019827 A1
(43) Pub. Date: Jan. 24, 2013

(54) FLUID BRAKE DEVICE AND VARIABLE VALVE TIMING APPARATUS

(71) Applicants: Kuniaki Oka, Nishio-city (JP); Jun Yamada, Okazaki-city (JP); Makoto Otsubo, Anjo-city (JP); Shuhei Oe, Nukata-gun (JP); Taketsugu Sasaki, Nagoya-city (JP); Seiichirou Washino, Nagoya-city (JP)

(72) Inventors: Kuniaki Oka, Nishio-city (JP); Jun Yamada, Okazaki-city (JP); Makoto Otsubo, Anjo-city (JP); Shuhei Oe, Nukata-gun (JP); Taketsugu Sasaki, Nagoya-city (JP); Seiichirou Washino, Nagoya-city (JP)

(73) Assignee: DENSO CORPORATION, Kariya-city (JP)

(21) Appl. No.: 13/553,085

(22) Filed: Jul. 19, 2012

(30) Foreign Application Priority Data
Jul. 23, 2011 (JP) 2011-161455

(51) Int. Cl. F16F 9/53; F01L 1/344

(52) U.S. Cl. 123/90.15; 188/267.2

(57) ABSTRACT

A fluid brake device has a brake shaft which penetrates a case. The case provides a fluid chamber for a magneto-rheological fluid. A magnetic seal has a magnetic seal sleeve which holds a small amount of the magneto-rheological fluid by magnetic flux. In addition to the magnetic seal, an axially pumping element is provided on an axial outside of the magnetic seal. The axially pumping element is provided by a shaft helical groove formed on an opposing wall of the brake shaft and/or a case helical groove formed on a surrounding wall. As the brake shaft rotates, the helical groove pushes the magneto-rheological fluid back to the magnetic seal. A combination of the magnetic seal and the axially pumping element may reduce leakage of the magneto-rheological fluid.

### CROSS REFERENCE TO RELATED APPLICATION

This application is based on Japanese Patent Application No. 2011-161455 filed on Jul. 23, 2011, the disclosure of which is incorporated herein by reference.

### TECHNICAL FIELD

The present disclosure relates to a fluid brake device and a variable valve timing apparatus having the fluid brake device.

### BACKGROUND

Conventionally, a fluid brake device is known in this field. One of the fluid brake devices includes a housing, a magneto-rheological fluid (MRF) in the housing, and a brake rotor. The brake rotor is rotatably supported in the housing in a manner the brake rotor comes in contact with the MRF. The fluid brake device further includes a magnetic flux control device which supplies magnetic flux through the MRF and variably control viscosity of the MRF. The fluid brake device can give braking torque with comparatively small electric power. The fluid brake device may be preferable for devices such as a variable valve timing apparatus. The variable valve timing apparatus adjusts a relative angular phase between a crankshaft and a camshaft according to a braking torque generated by the fluid brake device. The relative angular phase may be called as an engine phase indicating a valve operating timing.

JP2010-121614A discloses one of the fluid brake devices which has a sealing structure on the case. The sealing structure is a magnetic seal provided by a permanent magnet and flux guide members both arranged to surround the brake shaft. The magnetic seal catches a small amount of MRF to provide a fluid film to prevent the MRF flowing out to an outside of the sealing structure.

### SUMMARY

However, if an internal pressure is increased, the MRF caught in the magnetic seal may be leaked to the outside. The MRF leaked to the outside of the sealing structure may further flow away from the sealing structure.

It is an object of one of disclosures to reduce a leakage of the MRF to an outside of a case. It is another object of one of disclosure to reduce a leakage of the MRF by mechanical elements which can be easily formed on the fluid brake device.

According to an embodiment, a fluid brake device is provided. The fluid brake device comprises a case which defines a fluid chamber inside. A magneto-rheological fluid is kept in the fluid chamber. The magneto-rheological fluid has a viscosity variable in accordance with magnetic flux passing through. The fluid brake device comprises a control device which carries out variable control of the viscosity of the magneto-rheological fluid by varying the magnetic flux. The fluid brake device comprises a brake member which is rotatably supported on the case. The brake member has a brake shaft penetrating the case and a rotor being supported to come into contact with the magneto-rheological fluid so that the rotor receives a braking torque according to the viscosity of the magneto-rheological fluid. The fluid brake device comprises a magnetic seal disposed on the case. The magnetic seal is formed in an annular shape to surround the brake shaft. The magnetic seal defines a seal gap where a magnetic flux is supplied to hold the magneto-rheological fluid in the fluid chamber.

The fluid brake device comprises an axially pumping element disposed on an axial outside of the magnetic seal, which is an opposite side of the magnetic seal from the fluid chamber in an axial direction. The axially pumping element provides a helical path to push the magneto-rheological fluid back to the seal gap as the brake shaft rotates.

According to an embodiment, the axially pumping element may be provided by a shaft helical groove formed on an opposing wall. The opposing wall is formed on the brake shaft radially opposite to the surrounding wall. The shaft helical groove is formed in a helical shape inclined to be more distanced from the magnetic seal sleeve as the shaft helical groove is traced along the rotational direction of the brake member.

According to an embodiment, the axially pumping element may be provided by a case helical groove formed on the surrounding wall. The case helical groove is formed in a helical shape inclined to be approached to the magnetic seal sleeve as the case helical groove is traced along the rotational direction of the brake member.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view, on a line I-I in FIG. 2, showing a variable valve timing apparatus having a fluid brake device according to a first embodiment;

FIG. 2 is a sectional view on a line II-II in FIG. 1;

FIG. 3 is a sectional view on a line in FIG. 1;

FIG. 4 is a diagram for explaining characteristics of a magneto-rheological fluid (MRF);

FIG. 5 is an enlarged sectional view showing a part of the fluid brake device in FIG. 1;

FIG. 6A is a diagram for explaining flow path of the MRF;

FIG. 6B is a diagram for explaining flow path of the MRF;

FIG. 6C is a diagram for explaining flow path of the MRF;

FIG. 7 is an enlarged sectional view showing a part of a fluid brake device according to a second embodiment;

FIG. 8A is a diagram for explaining flow path of the MRF;

FIG. 8B is a diagram for explaining flow path of the MRF;

FIG. 8C is a diagram for explaining flow path of the MRF;

FIG. 9 is an enlarged sectional view showing a part of a fluid brake device according to a third embodiment;

FIG. 10 is, an enlarged sectional view showing a part of a fluid brake device according to a fourth embodiment;

FIG. 11 is an enlarged sectional view showing a part of a fluid brake device according to a fifth embodiment;

FIG. 12 is an enlarged sectional view showing a part of a fluid brake device according to a sixth embodiment;

FIG. 13 is an enlarged sectional view showing a part of a fluid brake device according to a seventh embodiment;

FIG. 14 is an enlarged sectional view showing a part of a fluid brake device according to a eighth embodiment; and

FIG. 15 is an enlarged sectional view showing a part of a fluid brake device according to a ninth embodiment.

### DETAILED DESCRIPTION

Hereinafter, embodiments of the present invention are described in detail referring to the attached drawings. In the description, redundant explanation is omitted by using the same reference numbers to indicate the same or corresponding members. In a case that only a part of component or part is described, other descriptions for the remaining part of component or part in the other description may be incorporated. The embodiments can be partially combined or partially exchanged in some forms which are clearly specified in the following description. In addition, it should be understood that, unless trouble arises, the embodiments can be partially combined or partially exchanged each other in some forms which are not clearly specified.

### First Embodiment

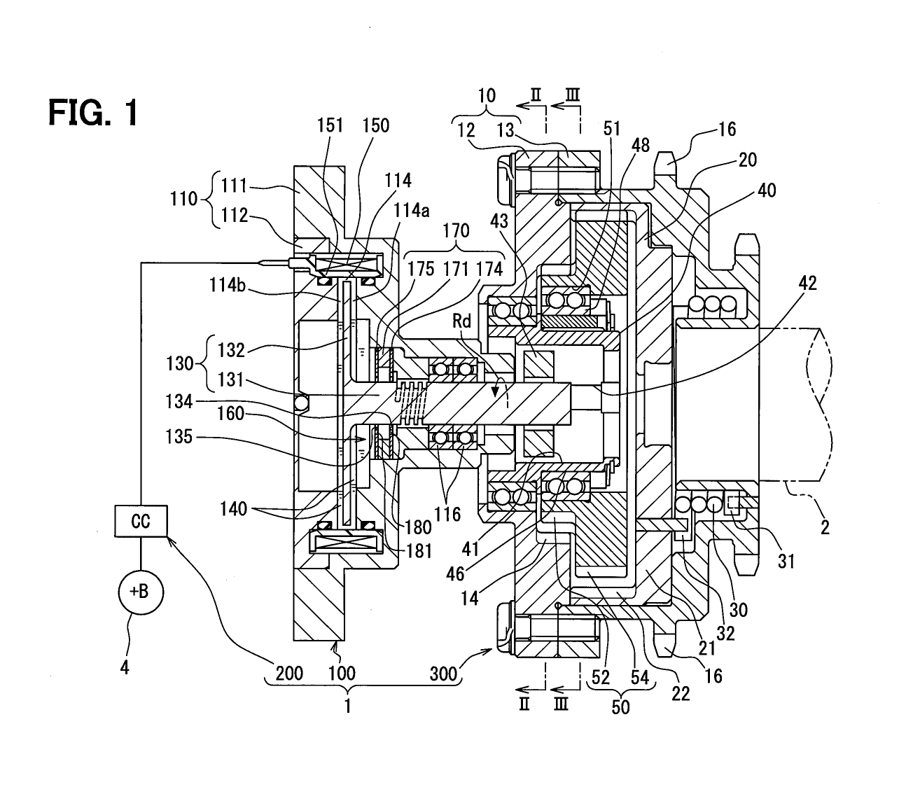

FIG. 1 shows a variable valve timing apparatus 1 having a fluid brake device 100 according to a first embodiment. The variable valve timing apparatus 1 is mounted on an engine on a vehicle. The variable valve timing apparatus 1 is installed in a torque transmission train which transmits engine torque to the camshaft 2 from the crankshaft. The camshaft 2 shown in FIG. 1 opens and closes at least one of intake valves among valves of the internal combustion engine. The variable valve timing apparatus 1 adjusts the valve timing of the intake valve.

As shown in FIGS. 1-3, in addition to the fluid brake device 100, the variable valve timing apparatus 1 is configured by components such as a control circuit (CC) 200 and a phase adjusting mechanism 300. The variable valve timing apparatus 1 provides a target valve timing by adjusting engine phase which is a relative phase of the camshaft 2 to the crankshaft.

### Fluid Brake Device

The fluid brake device 100 is an electric driven device. The fluid brake device 100 is an electromagnetic device. The fluid brake device 100 has components such as a case 110, a brake member 130, a magneto-rheological fluid (MRF) 140, a sealing structure 160, and a solenoid coil 150.

The case 110 is formed in a hollow shape. The case 110 has a fixing member 111 and a cover member 112. The case 110 defines a fluid chamber 114 therein. The fixing member 111 is formed in a cylindrical shape with steps. The fixing member 111 is made of a magnetic material. The fixing member 111 is fixedly secured on a chain case (not illustrated) which is a stable portion of the internal combustion engine. The cover member 112 is formed in a circular dish shape. The cover member 112 is made of a magnetic material that may be the same as or similar to the fixing member 111. The cover member 112 is disposed on the fixing member 111 to be placed on an opposite side to the phase adjusting mechanism 300. In other words, the fixing member 111 has a far side which is opposite to a side close to the phase adjusting mechanism 300 and defines an end opening closed by the cover member 112 disposed thereon. The case 110 is disposed on an axial side of the phase adjusting mechanism 300 to place the fixing member 111 between the cover member 112 and the phase adjusting mechanism 300 in an axial direction. In this embodiment, the axial direction corresponds to the longitudinal direction of the brake member 130 and the camshaft 2. The cover member 112 is inserted into the fixing member 111 in a coaxial manner and is fixedly secured in a sealing manner. The cover member 112 defines a chamber 114 with the fixing member 111. The chamber 114 may be also referred to as a fluid chamber 114 defined inside the case 110.

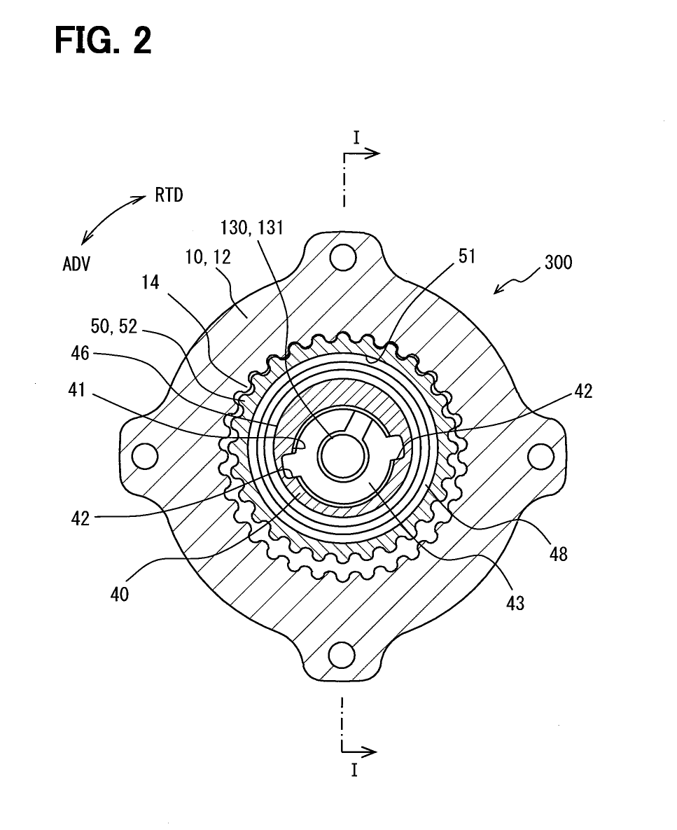

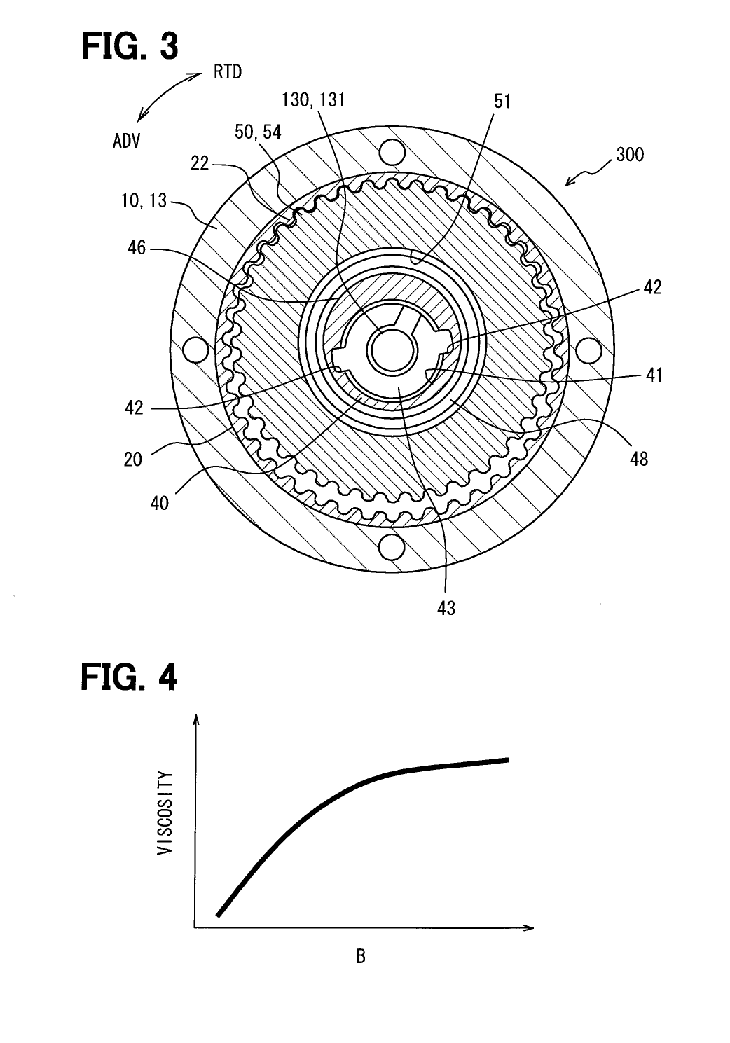

The brake member 130 is made of magnetic material, and has a brake shaft 131 and a brake rotor 132. The brake shaft 131 is formed in a shaft shape. The brake shaft 131 is disposed to penetrate the fixing member 111, i.e., a part of the case 110. In other words, the case 110 has a wall which is placed on a side close to the phase adjusting mechanism 300 and is penetrated by the brake shaft 131. The brake shaft 131 has an outside end which is placed on an outside of the case 110 and is engaged with the phase adjusting mechanism 300. Therefore, the phase adjusting mechanism 300 is engaged with the brake shaft 131 at an outside of the case 110 for adjusting an relative phase between the crankshaft and the camshaft according to the braking torque acting on the brake member 130. The brake shaft 131 has a middle portion in the axial direction. The middle portion is rotatably supported by a bearing 116 disposed on the fixing member 111, i.e., the case 110. During an operation of the internal combustion engine, torque outputted from the crankshaft is transmitted via the phase adjusting mechanism 300 and drives the brake member 130 to rotate in a predetermined direction, e.g., the counterclockwise direction in FIG. 2 and FIG. 3.

The brake rotor 132 is formed in a circular disc shape. The brake rotor 132 may have a plurality of through holes to communicate both sides of the brake rotor 132. The brake rotor 132 is formed on a proximal end of the brake shaft 131. In other words, the brake member 130 is supported on only one side of the brake rotor 132. The brake rotor 132 is disposed on the proximal end opposed to the distal end close to the phase adjusting mechanism 300 and is radially protruded from the proximal end. The fluid chamber 114 has a part which is placed and defined between the brake rotor 132 and the fixing member 111 and provides a magnetic gap 114a. The fluid chamber 114 also has a part which is placed and defined between the brake rotor 132 and the cover member 112 and provides a magnetic gap 114b.

The fluid chamber 114 contains the MRF 140. The MRF 140 is partially or completely filled in the fluid chamber 114. The MRF 140 is a kind of functional fluid which is made of nonmagnetic base liquid and magnetic particles suspended in the base liquid. The base liquid may be provided by a liquid that is nonmagnetic and hydrophobic property. For example, oil which is the same kind of lubrication oil for the internal combustion engine may be used as the base liquid. The magnetic particles may be provided by a powdered magnetic material, such as carbonyl iron etc. The MRF 140 changes viscosity according to a magnetic flux passing therethrough. The MRF 140 shows a characteristic of apparent viscosity that is increased as an amount of magnetic flux passing therethrough is increased. The apparent viscosity is increased in a proportional fashion to the amount of magnetic flux. In addition, the MRF 140 shows a characteristic of yield stress that is increased proportional to the viscosity. The MRF 140 is kept in the fluid chamber 114. The MRF 140 has a viscosity variable in accordance with magnetic flux passing through. The brake member 130 provides a brake member which is rotatably supported on the case 110. The brake member 130 has a brake shaft 131 penetrating the case 110 and a rotor 132 being supported to come into contact with the MRF 140 so that the rotor 132 receives a braking torque according to the viscosity of the MRF 140.

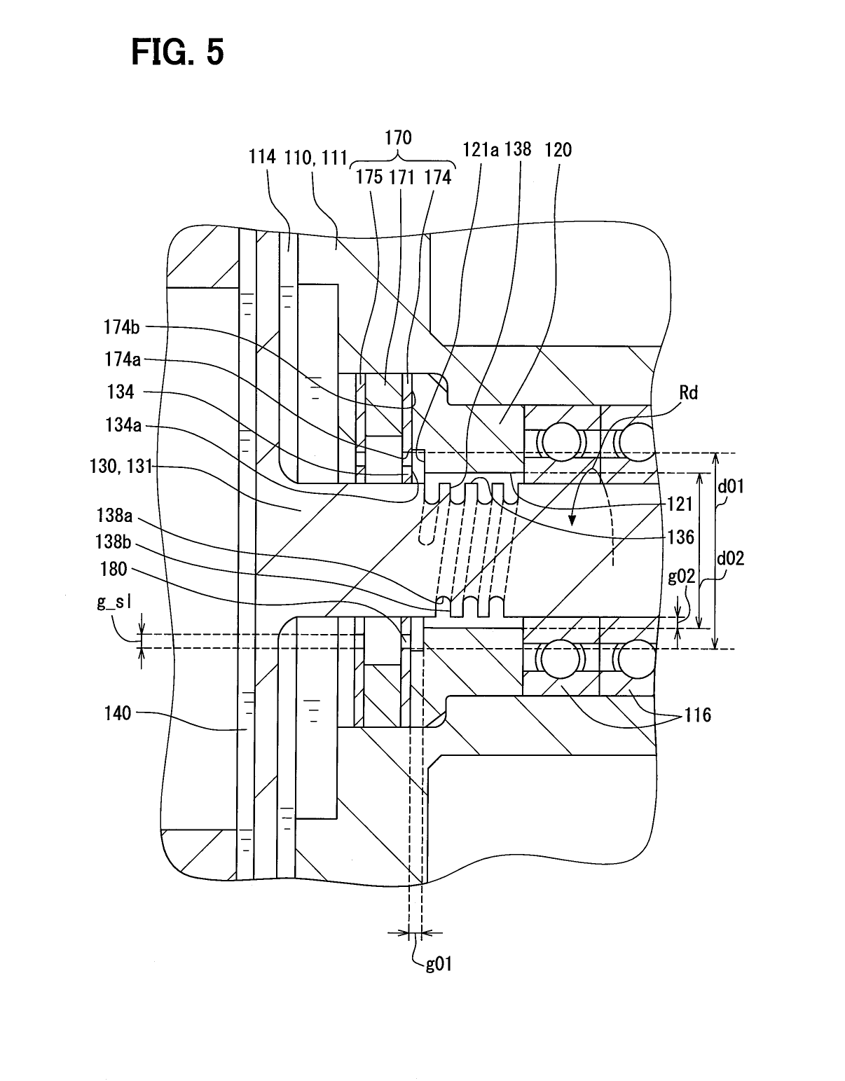

As shown in FIG. 1 and FIG. 5, the sealing structure 160 is formed in a part which is located between the fluid chamber 114 and the bearing 116 with respect to the axial direction in the case 110. The sealing structure 160 has a shaft flux guides 134 and 135 and a magnetic seal sleeve 170. The shaft flux guides 134 and 135 are made of a magnetic material and are disposed on the brake shaft 131 of the brake member 130. The shaft flux guides 134 and 135 are formed on the brake shaft 131 to modulate magnetic flux for sealing purpose. The magnetic seal sleeve 170 is formed in a ring shape and is disposed on an outside of the shaft flux guides 134 and 135 to surround the shaft flux guides 134 and 135 along a rotational direction of the brake shaft 131. The shaft flux guides 134 and 135 are projected from the brake shaft 131 in the radial outside direction. The magnetic seal sleeve 170 has a permanent magnet 171 and a pair of flux guide yokes 174 and 175. The permanent magnet 171 is placed between the flux guide yokes 174 and 175 to supply magnetic flux. The flux guide yokes 174 and 175 are made of magnetic material. A seal gap 180 is formed between the flux guide yoke 174 and the shaft flux guide 134. A seal gap 181 is formed between the flux guide yoke 175 and the shaft flux guide 135.

Magnetic flux from the permanent magnet 171 is guided through the flux guide yokes 174 and 175 and the seal gaps 180 and 181 to the shaft flux guide 134. The magnetic flux may be concentrated at the seal gaps 180 and 181. A small amount of the MRF 140 flows into the seal gaps 180 and 181. The magnetic flux passing the seal gaps 180 and 181 affects the MRF 140 to increase viscosity and catch the MRF 140 in the seal gaps 180 and 181. The MRF 140 is caught in the seal gaps 180 and 181 in annular film shapes. In this way, the MRF 140 performs a self-seal function in which the MRF 140 it self suppresses or prevents flow of the MRF 140 from an inside of the case 110 to an outside of the case 110. The seal structure 160 provides a magnetic seal disposed between the case 110 and the brake shaft 131. The magnetic seal is formed in an annular shape to surround the brake shaft 131. The magnetic seal defines a seal gap 180, 181 where a magnetic flux is supplied to hold a small amount of the MRF 140.

The solenoid coil 150 has a resin bobbin 151 and a metal wire wound on the resin bobbin 151. The solenoid coil 150 is disposed on a radial outside of the brake rotor 132. The solenoid coil 150 is coaxially disposed with the brake rotor 132. The solenoid coil 150 is supported on the case 110 in a manner that the solenoid coil 150 is inserted and tightened between the fixing member 111 and the cover member 112 in the axial direction. By supplying energizing current to the solenoid coil 150, the solenoid coil 150 supplies magnetic flux flowing and passing through the fixing member 111, the magnetic gap 114a, the brake rotor 132, the magnetic gap 114b, and the cover member 112 in this order in the axial direction.

The magnetic flux passes through the MRF 140 in the magnetic gaps 114a and 114b. The MRF 140 changes, i.e., increases its viscosity and provide an increased viscous drag between the housing 110 and the brake member 130. During operation of the internal combustion engine, the brake member 130 rotates relative to the case 110, the brake member 130 receives a braking torque from the MRF 140. The braking torque acts to make speed down and retard the rotation of the brake member 130, i.e., the brake rotor 132. Thus, the solenoid coil 150 generates the magnetic flux according to supplied current. The MRF 140 generates a viscosity according to the magnetic flux generated by the solenoid coil 150. The brake member 130 receives and inputs the braking torque according to the viscosity of the MRF 140. In other words, the solenoid coil 150 modulates the magnetic flux and the braking torque. The solenoid coil 150 may provide a part of a control device which carries out variable control of the viscosity of the MRF 140 by varying the magnetic flux.

### Control Circuit

A controller 200 is provided to control an amount of energizing current supplied to the solenoid coil 150. The controller 200 is mainly provided by a microcomputer and may be referred to as a current control circuit. The controller 200 is mounted on the vehicle at a location apart from and exterior of the fluid brake device. The controller 200 is connected to both the solenoid coil 150 and a battery 4. During the internal combustion engine is not operated, the controller 200 is not supplied with the electric power from the battery 4 and cut current supply to the solenoid coil 150. Therefore, at this time, the magnetic flux is not generated, and no braking torque is inputted into the brake member 130.

On the other hand, during an operation of the internal combustion engine, the controller 200 is supplied with the electric power from the battery 4, and controls an amount of current supply to the solenoid coil 150. As a result, the solenoid coil 150 generates a regulated amount of the magnetic flux which passes through the MRF 140. Therefore, a variable control of the viscosity of the MRF 140 is performed by the controller 200. The brake torque inputted in the brake member 130 is controlled in a variable fashion in accordance with the current supplied to the solenoid coil 150. The controller 200 may be a part of the control device which carries out variable control of the viscosity of the MRF 140 by varying the magnetic flux.

### Phase Adjusting Mechanism

As shown in FIGS. 1 to 3, the phase adjusting mechanism 300 is provided with a planetary gear mechanism and an assisting mechanism. The planetary gear mechanism includes a drive rotor 10, a driven rotor 20, a planetary carrier 40, and a planetary gear 50. The assisting mechanism includes an assisting member 30.

The drive rotor 10 is formed in a cylindrical shape. The drive rotor 10 has a gear member 12 and a sprocket member 13 placed on the same axis and joined by screws. As shown in FIGS. 1 and 2, the gear member 12 is formed in an annular plate shape. The gear member 12 is formed with a drive side internal-gear 14 which has tooth tops having diameter that are smaller than that of tooth bottoms. The sprocket member 13 is formed in a cylindrical shape. The sprocket member 13 is formed with a plurality of teeth 16 protruding outwardly from a peripheral wall portion. The sprocket member 13 is engaged with the crankshaft via a timing chain (not shown) which is provided between the teeth 16 and the crankshaft. Engine torque outputted from the crankshaft is transmitted to the sprocket member 13 through the timing chain. When the engine torque if transmitted, the drive rotor 10 rotates with the crankshaft in a synchronized manner. For example, the drive rotor 10 rotates in the counterclockwise rotation in FIGS. 2 and 3.

The driven rotor 20 is formed in a cylindrical shape with a bottom wall. The driven rotor 20 is disposed in a radial inside of the sprocket member 13 in a coaxial manner. The driven rotor 20 provides a bottom wall that provides a fixing portion 21 which is placed on the camshaft 2 in a coaxial manner and is fixedly secured on the camshaft 2 by a bolt. The driven rotor 20 is supported to be able to rotate with the camshaft 2 and to rotate relatively to the drive rotor 10. The driven rotor 20 rotates in the counterclockwise rotation in FIGS. 2 and 3.

The driven rotor 12 has a cylindrical wall on which a driven side internal-gear 22 is formed. The gear 22 has tooth tops having diameter that are smaller than that of tooth bottoms. The driven side internal-gear 22 has an inner diameter that is larger than an inner diameter of the drive side internal-gear 14. The driven side internal-gear 22 has greater number of teeth than that of the drive side internal-gear 14. The drive side internal-gear 14 and the driven side internal-gear 22 are disposed next to each other in the axial direction and on the same axis. The drive side internal-gear 14 is located between the driven side internal-gear 22 and the fluid brake device 100. The driven side internal-gear 22 is disposed between the drive side internal-gear 14 and the camshaft 2. The driven side internal-gear 22 is disposed next the drive side internal-gear 14 on a side opposite to a side close to the fluid brake device 100.

The assist member 30 is made of a torsion coil spring and is disposed on a radial inside of the sprocket member 13 in a coaxial manner. One end 31 of the assist member 30 is engaged on the sprocket member 13. The other end 32 of the assist member 30 is engaged on the fixing portion 21. The assist member 30 generates an assist torque by deformed in a twisting mode between the rotors 10 and 20. The assist torque pushes and urges the driven rotor 20 in a retard side, i.e., a delaying side with respect to the drive rotor 10.

The planetary carrier 40 is formed in a cylindrical shape having a cylindrical wall. The cylindrical wall is formed with a transmitter portion 41 through which the brake torque on the brake member 130 is transmitted. The transmitter portion 41 defines a circular through hole therein. The rotors 10 and 20, the brake member 130 and the transmitter portion 41 are arranged on the same axis. A pair of grooves 42 is formed on the transmitter portion 41. A joint member 43 is engaged with the grooves 42 and the brake shaft 131. The transmitter portion 41 and the brake shaft 131 are engaged via the joint member 43. The planetary carrier 40 is supported so that the planetary carrier 40 is able to rotate with the brake member 130 as a unit and that the planetary carrier 40 is able to rotate relative to the drive rotor 10. The planetary carrier 40 rotates in the counterclockwise rotation in FIGS. 2 and 3.

The planetary carrier 40 provides a cylindrical wall on which a bearing portion 46 for carrying the planetary gear 50 is formed. The bearing portion 46 provides a circular outer surface which has an axis shifted slightly from the axis of the rotors 10 and 20, and the brake shaft 131. In other words, the bearing portion 46 is eccentric to the rotors 10 and 20 and the brake shaft 131 and provides an eccentric support portion. The planetary gear 50 defines a center hole 51. A planetary bearing 48 is inserted and fixed on the inside of the center hole 51. The bearing portion 46 is inserted in the planetary bearing 48 and the center hole 51 to support the planetary gear 50 in an eccentric manner to the axis of the camshaft 2. The bearing portion 46, the planetary bearing 48 and the planetary gear 50 are arranged on the same axis. As the planetary carrier 40 rotates about the axis of the rotors 10 and 20, the bearing portion 46 orbits and revolves about the axis of the rotors 10 and 20. The planetary gear 50 is supported by the bearing 46 so as to perform a planetary motion. In the planetary motion, the planetary gear 50 orbits about an center provided by the rotors 10 and 20 in an orbiting direction of the bearing portion 46. Simultaneously, the planetary gear 50 rotates about an eccentric center provided by the bearing portion 46. Therefore, when the planetary carrier 40 rotates about the axis of the rotors 10 and 20 in an orbiting direction of the planetary gear 50, the planetary gear 50 performs the planetary motion.

The planetary gear 50 is formed in a cylindrical shape with a step between a large diameter portion and a small diameter portion. The planetary gear 50 provides a cylindrical wall. The planetary gear 50 has outer gears 52 and 54 on the large diameter portion and the small diameter portion respectively. The outer gears 52 and 54 are formed on outside surface of the cylindrical wall. The outer gears 52 and 54 have teeth that have tooth tops with larger diameter than that of tooth bottoms. The outer gear 52 provides a drive side outer gear 52 and is disposed in a radial inside of the drive side internal gear 14 to be partially meshed with. The outer gear 52 is partially meshed with the drive side internal gear 14 on a side to which the bearing portion 46 is shifted from the axis of the rotors 10 and 20 and the brake shaft 131. The outer gear 52 and the outer gear 54 are arranged next to each other in the axial direction. The outer gear 52 is located closer to the fluid brake device 100 than the outer gear 54. The outer gear 54 is placed next to the outer gear 52 on a side opposite to the fluid brake device 100. The outer gear 54 provides a driven side outer gear 54 and is disposed in a radial inside of the driven side internal gear 22 to be partially meshed with. The outer gear 54 is partially meshed with the driven side internal gear 22 on a side to which the bearing portion 46 is shifted from the axis of the rotors 10 and 20 and the brake shaft 131. The driven side outer gear 54 has an outer diameter that is larger than an outer diameter of the drive side outer gear 52. The driven side outer gear 54 has greater number of teeth than that of the drive side outer gear 52. The driven side outer gear 54 has less number of teeth than that of the driven side internal gear 22 by a predetermined number. The drive side outer gear 52 has less number of teeth than that of the drive side internal gear 14 by the predetermined number. Therefore, the gears 52 and 54 have less number of teeth than the gears 14 and 22 by the same number.

The phase adjusting mechanism 300 adjusts the engine phase by a balance among the braking torque input to the brake member 130, the assist torque of the assist member 30, and a fluctuation torque transmitted from the camshaft 2 to the brake member 130. The assist torque acts on the brake member 130 in a direction opposite to the braking torque.

When the solenoid coil 150 adjust the braking torque so that the brake member 130 and the drive rotor 10 rotate at the same rotating speed, the planetary carrier 40 does not revolves with respect to the drive rotor 10. The planetary gear 50 does not perform the planetary motion and revolves together with the rotors 10 and 20. As a result, the phase adjusting mechanism 300 keeps the engine phase. From the above holding condition, when the solenoid coil 150 increases the braking torque so that the brake member 130 makes the planetary carrier 40 rotates slower than the drive rotor 10, the planetary carrier 40 revolves relative to the drive rotor 10 in a retard, i.e., delaying direction. The planetary carrier 40 revolves against the assist torque. The planetary gear 50 performs the planetary motion and drives the drive rotor 10 and the driven rotor 20 by gears 14, 52, 54, and 22. In this case, the driven rotor 20 is relatively rotated to the drive rotor 10 in an advancing direction. As a result, the phase adjusting mechanism 300 advances the engine phase. From the holding condition, when the solenoid coil 150 decreases the braking torque so that the brake member 130 makes the planetary carrier 40 rotates higher than the drive rotor 10, the planetary carrier 40 revolves relative to the drive rotor 10 in an advancing direction. The planetary carrier 40 revolves by receiving the assist torque. The planetary gear 50 performs the planetary motion and drives the drive rotor 10 and the driven rotor 20 by gears 14, 52, 54, and 22. In this case, the driven rotor 20 is relatively rotated to the drive rotor 10 in a delaying direction. As a result, the phase adjusting mechanism 300 delays the engine phase.

### Seal Structure

The magnetic seal sleeve 170 divides the inside of the case 110 in to an inside and an outside. Therefore, in the following explanation, a region on a side to the fluid chamber 114 from the magnetic seal sleeve 170 may be referred to as the inside or the inside of the magnetic seal sleeve 170. A region on an opposite side to the fluid chamber 114 side from the magnetic seal sleeve 170 may be referred to as the outside or the outside of the magnetic seal sleeve 170.

As shown in FIGS. 1 and 5, the case 110 has the nonmagnetic member 120. The nonmagnetic member 120 is formed in a thick cylindrical shape as a whole, by nonmagnetic material, such as a copper alloy. The nonmagnetic member 120 is coaxially arranged with the brake shaft 131. The nonmagnetic member 120 is fixed on an inside of the fixing member 111 of the case 110. The nonmagnetic member 120 has axial ends. The nonmagnetic member 120 has a one axial end which is closely located to the magnetic seal sleeve 170 and is located to come in contact with an end face 174b of the flux guide yoke 174. The nonmagnetic member 120 has the other axial end which is located to come in contact with the bearing 116. A radial inside portion of the nonmagnetic member 120 provides a surrounding wall 121.

The surrounding wall 121 is placed on the outside of the magnetic seal sleeve 170. The surrounding wall 121 surrounds the brake shaft 131 along the rotational direction Rd of the brake member 130. The surrounding wall 121 surrounds the brake shaft 131 over a certain axial length which is longer than an axial length of the magnetic seal sleeve 170. The nonmagnetic member 120 is made of nonmagnetic material. Therefore, the surrounding wall 121 can restrict the magnetic flux generated and guided by the permanent magnet 171 of the magnetic seal sleeve 170. The surrounding wall 121 is disposed on the axial side of the flux guide yoke 174 and 175. The surrounding wall 121 is coaxially arranged with the flux guide yoke 174 and 175, i.e., the magnetic seal sleeve 170.

The surrounding wall 121 has an end face 121a which faces the shaft flux guide 134 and is distanced from an end face 134a of the shaft flux guide 134. The end face 121a of the surrounding wall 121 and the end face 134a of the shaft flux guide 134 define a gap g01 between them. The gap g01 is fluidly communicated to the seal gap 180. An inner diameter d02 of the inner circumference surface of the surrounding wall 121 is formed smaller than an inside diameter d01 of the inner circumference surface 174a of the flux guide yoke 174 of the magnetic seal sleeve 170. Thereby, the seal gap 180 formed by the flux guide yoke 174 is located on a radial outer side than the inner circumference surface of the surrounding wall 121 in a radial direction. The seal gap 180 is also located on a side to the fluid chamber 114 from the end face 121 of the surrounding wall 121 with respect to an axial direction. In other words, the seal gap 180 is located between the magnetic seal sleeve 170 and the end face 121a.

The brake shaft 131 of the brake member 130 is formed with an opposing wall 136 and a shaft helical groove 138. The opposing wall 136 is coaxially formed with the surrounding wall 121. The opposing wall 136 is a part of an outer surface of the brake shaft 131. The opposing wall 136 faces the surrounding wall 121 in the radial direction. A radial gap g02 is formed between the opposing wall 136 and the surrounding wall 121. In this embodiment, an axial gap g01 defined between the end face 121a of the surrounding wall 121 and the end face 134a of the shaft flux guide 134 is formed wider than the radial gap g02 between the opposing wall 136 and the surrounding wall 121. In other words, the brake member 130 has the shaft flux guide 134 projecting from the brake shaft 131 in a radial outside direction. The shaft flux guide 134 defines the seal gap 180 with the magnetic seal sleeve 170, i.e., the flux guide yoke 174 at a fluid chamber side of the end face 121a of the surrounding wall 121. The shaft flux guide 134 and the end face 121a of the surrounding wall 121 defines an axial gap g01 which is wider than a radial gap g02 between the opposing wall 136 and the surrounding wall 121.

The brake shaft 131 provides the opposing wall 136 radially opposite to the surrounding wall 121. The shaft helical groove 138 is formed on the opposing wall 136. The shaft helical groove 138 is formed in a helical shape inclined to be more distanced from the magnetic seal sleeve 170 as the shaft helical groove 138 is traced along the rotational direction Rd of the brake member 130. In the longitudinal cross section of the brake shaft 131, the shaft helical groove 138 provides a U-shaped cross section. The shaft helical groove 138 provides a bottom 138a and a pair of side walls 138b, which both extend in a helical manner. The bottom 138a is formed in the shape of a semicircle in the longitudinal cross section. The pair of side walls 138b are opposed each other in the axial direction. The pair of side walls 138b extends along the radial direction of the brake shaft 131 from the bottom 138b to a radial outer surface. The shaft helical groove 138 circles around the opposing wall 136 two or more times. The shaft helical groove 138 has a unitary width along the helical direction. In other words, a distance between a pair of facing portions in the axial direction is constant.

The shaft helical groove 138 and the surrounding wall 121 provide an axially pumping element. The axially pumping element is disposed on an axial outside of the magnetic seal, i.e., the seal structure 160. The outside of the magnetic seal is an opposite side of the magnetic seal from the fluid chamber in an axial direction. The axially pumping element provides a helical path to push the MRF 140 back to the seal gap as the brake shaft 132 rotates. The axially pumping element may be provided by a shaft helical groove 138 formed on the opposing wall 136. The opposing wall 136 is formed on the brake shaft 131 radially opposite to the surrounding wall 121. The shaft helical groove 138 is formed in a helical shape inclined to be more distanced from the magnetic seal sleeve 170 as the shaft helical groove 138 is traced along the rotational direction of the brake member 130. The shaft helical groove 138 has an inside end located close to but is not overlaps with the magnetic seal sleeve 170. The shaft helical groove 138 has an outside end located close to but is not reaches to the bearing 116. In other words, the shaft helical groove 138 is only formed on an area to face the surrounding wall 121. Therefore, the shaft helical groove 138 is completely covered with the surrounding wall 121 with respect to the radial direction.

The fluid brake device 100 may return the MRF 140, which reaches to the outside of the magnetic seal sleeve 170, to the seal gap 180 by the shaft helical groove 138.

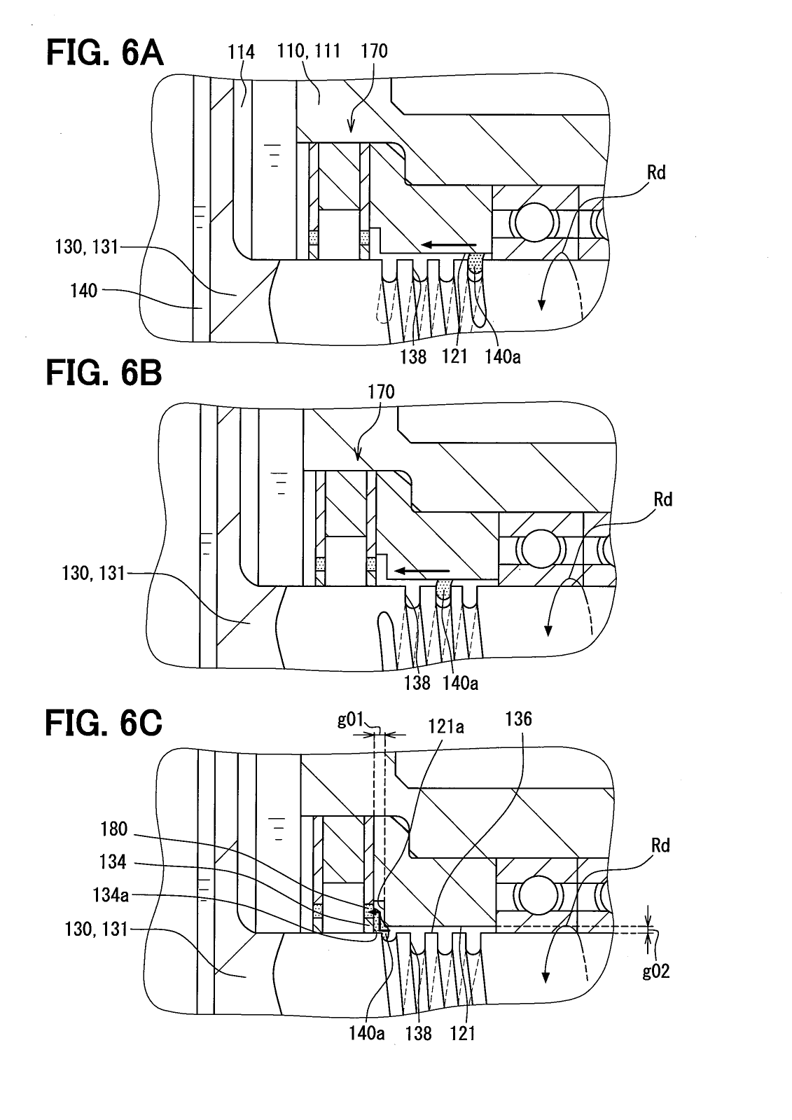

If the MRF 140 in the fluid chamber 114 is expanded by a thermal expansion, an internal pressure may be increased in the fluid chamber 114, and a small part of the MRF 140 may be leaked to the outside of the magnetic seal sleeve 170. FIG. 6A shows the MRF 140a which is reached to the outside of the magnetic seal sleeve 170. The MRF 140a also contains the base liquid as the main component. The base liquid is nonmagnetic and cannot be easily caught by magnetic flux. The. MRF 140a may be caught by the shaft helical groove 138 formed on the brake shaft 131. The MRF 140a caught by the shaft helical groove 138 is forced outwardly and comes in contact with the surrounding wall 121 by receiving a centrifugal force generated by a rotation of the brake member 130.

As the brake member 130 rotates, the shaft helical groove 138 works as a screw. The MRF 140a contacting with the surrounding wall 121 also receives friction on the surrounding wall. Therefore, the MRF 140a may sticks on the surrounding wall 121 and may be kept on the surrounding wall strongly. The MRF 140a may receive pushing force in a counter direction of the rotational direction Rd of the brake member 130. As the shaft helical groove 138 works as a screw, the shaft helical groove 138 pushes the MRF 140a to the magnetic seal sleeve 170. As the brake member 130 rotates, the MRF 140a caught in the shaft helical groove 138 moves to trace the shaft helical groove 138 in a counter direction of the rotational direction Rd of the brake member 130. The shaft helical groove 138 is formed to be distanced away from the magnetic seal sleeve 170 as the shaft helical groove 138 is traced along the rotational direction Rd. The MRF 140a follows the shaft helical groove 138 in the counter direction of the rotational direction Rd as the brake member 130 rotates in the rotational direction Rd. As a result, the MRF 140a is pushed to and moves toward the magnetic seal sleeve 170 as shown in FIG. 6B.

The MRF 140a reaches to the inside end of the shaft helical groove 138 close to the magnetic seal sleeve 170. Then, the MRF 140a is pushed out to the radial gap g02 between the opposing wall 136 and the surrounding wall 121 by rotation of the brake member 130 in the rotational direction Rd, as shown in FIG. 6C. Then, the MRF 140a is again caught by the seal gap 180 through the gap g02 and an axial gap g01 between the end face 121a of the surrounding wall 121 and the end face 134a of the shaft flux guide 134.

According to the embodiment, the MRF 140a, which moves to the outside of the magnetic seal sleeve 170 and has high risk of leakage from the case 110, may be pushed back to and returns to the seal gap 180 by the shaft helical groove 138. Therefore, it is possible to reduce leakage of the MRF 140 to the outside of the case 110.

In addition, the seal gap 180 is placed on a radial outside of the shaft helical groove 138. The movement of the MRF 140a from the shaft helical groove 138 to the seal gap 180 can be facilitated by the centrifugal force acting on the MRF 140a. In addition, the gap g01 is set wider than the gap g02. The movement of the MRF 140a from the shaft helical groove 138 to the seal gap 180 can be further facilitated. As mentioned above, the MRF 140a, which is pushed and returned by the surrounding wall 121 and the shaft helical groove 138, can return easily to the seal gap 180 again. Therefore, it is possible to improve the certainty of performing the function for reducing leakage of the MRF 140 to the outside of the case 110.

In the first embodiment, since the surrounding wall 121 made of the nonmagnetic material restricts the magnetic flux, the magnetic flux generated by the permanent magnet 171 cannot pass the surrounding wall 121 easily. Therefore, it is possible to reduce an amount of the MRF 140a attracted to and attached on the surrounding wall 121 by the magnetic flux generated by the permanent magnet 171. As mentioned above, since the MRF 140a placed on an outside of the seal sleeve keeps movable fluidic state, the MRF 140a may be surely returned to the seal gap 180 of the magnetic seal sleeve 170 by flowing along the shaft helical groove 138. Therefore, it is possible to improve the certainty of performing the function for reducing leakage of the MRF 140 to the outside of the case 110.

It is possible to reduce an amount of change on the braking characteristics of the fluid brake device 100 resulting from a leakage of the MRF 140. It is possible to maintain an adjusting accuracy of the engine phase which may be influenced by the braking characteristics. Therefore, the fluid brake device 100 in this embodiment is suitable for especially the variable valve timing device 1 that is required an accurate engine phase adjustment.

### Second Embodiment

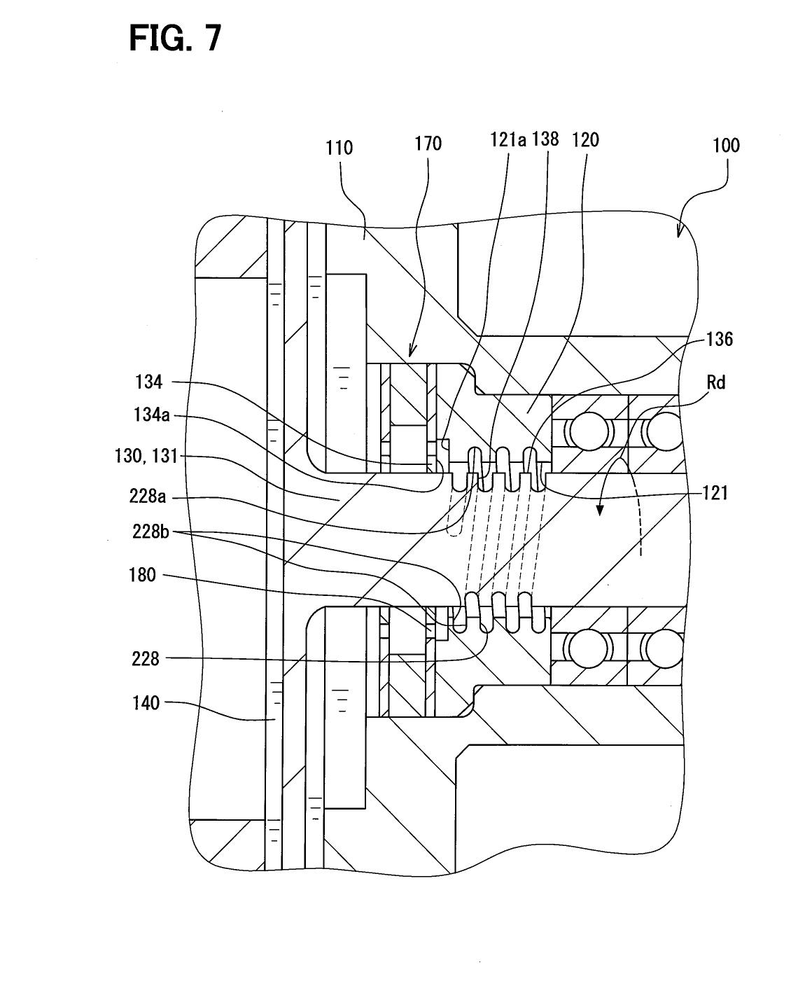

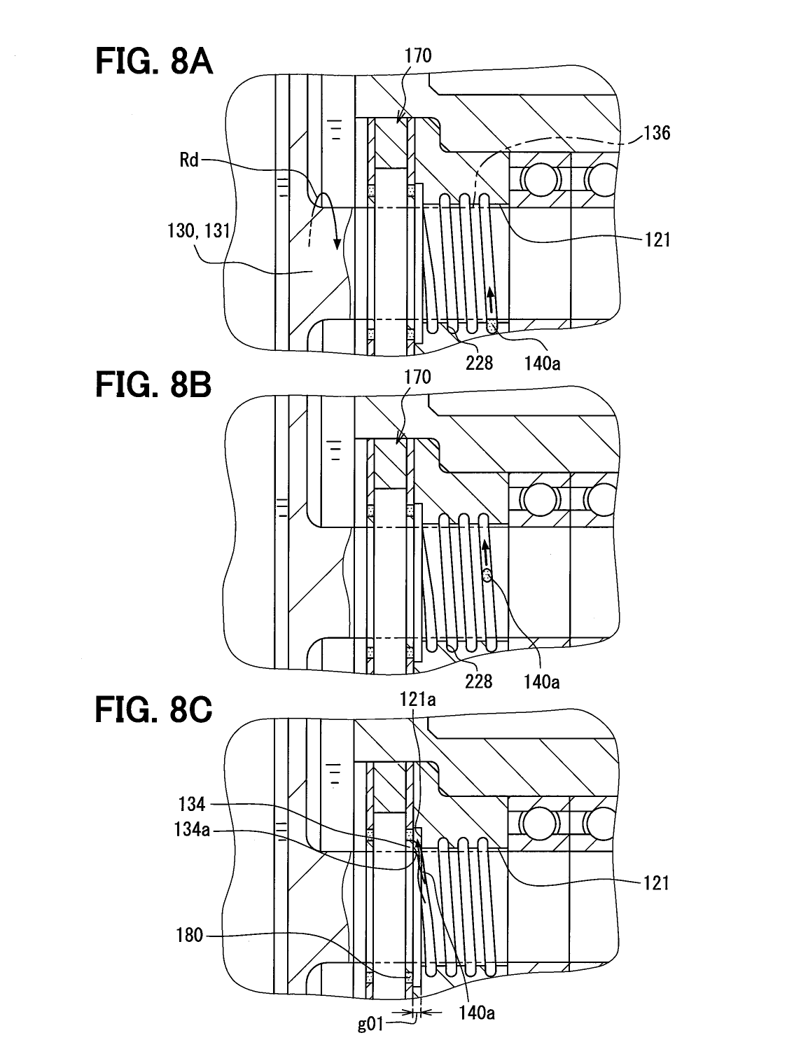

As shown in FIGS. 7 and 8, the second embodiment is a modification of the first embodiment. In the second embodiment, a case helical groove 228 is formed on the surrounding wall 121 of the nonmagnetic member 120 with the shaft helical groove 138 of the brake shaft 131. The case helical groove 228 is formed on the surrounding wall 121. The case helical groove 228 is formed in a helical shape inclined to be more closely approached to the magnetic seal sleeve as the case helical groove 228 is traced along the rotational direction of the brake member 130. The case helical groove 228 provides the axially pumping element. The case helical groove is formed on the surrounding wall 121. The case helical groove 228 is formed in a helical shape inclined to be approached to the magnetic seal sleeve 170 as the case helical groove 228 is traced along the rotational direction of the brake member 130. In the longitudinal cross section of the nonmagnetic member 120, the case helical groove 228 provides a U-shaped cross section. The case helical groove 228 provides a bottom 228a and a pair of side walls 228b, which both extend in a helical manner. The bottom 228a is formed in the shape of a semicircle in the longitudinal cross section. The pair of side walls 228b are opposed each other in the axial direction. The pair of side walls 228b extends along the radial direction of the nonmagnetic member 120 from the bottom 228b to a radial inner surface. The case helical groove 228 circles around the surrounding wall 121 two or more times. The case helical groove 228 has a unitary width along the helical direction. In other words, a distance between a pair of facing portions in the axial direction is constant.

The fluid brake device 100 may return the MRF 140, which reaches to the outside of the magnetic seal sleeve 170, to the seal gap 180 by the case helical groove 228.

The MRF 140a which moved to the outside of the magnetic seal sleeve 170 shown in FIG. 8A may be caught by the case helical groove 228 formed on the surrounding wall 121. The MRF 140a caught in the case helical groove 228 also come in contact with the opposing wall 136 of the brake shaft 131 which rotates in the rotational direction Rd. The MRF 140a contacting with the opposing wall 136 receives friction on the opposing wall 136. The MRF 140a may receive pushing force in the rotational direction Rd of the brake member 130 from the opposing wall 136.

The case helical groove 228 is formed to be approached to the magnetic seal sleeve 170 as the case helical groove 228 is traced along the rotational direction Rd. The MRF 140a follows the case helical groove 228 in the rotational direction Rd as the brake member 130 rotates in the rotational direction Rd. As a result, the MRF 140a is pushed to and moves toward the magnetic seal sleeve 170 as shown in FIG. 8B. As the brake member 130 rotates, the MRF 140a caught in the case helical groove 228 moves to trace the case helical groove 228 in the rotational direction Rd of the brake member 130.

The MRF 140a reaches to the inside end of the case helical groove 228 close to the magnetic seal sleeve 170. Then, the MRF 140a is again caught by the seal gap 180 through the gap g01 between the end face 121a of the surrounding wall 121 and the end face 134a of the shaft flux guide 134 as shown in FIG. 8C.

In addition, the centrifugal force acts on gas contained in the MRF 140a which moves within the case helical groove 228. As a result, the gas being mixed in the MRF 140a may be separated from the MRF 140a. Thus, the case helical groove 228 may work as a gas liquid separator which separates the gas from the MRF 140a.

According to the embodiment, the MRF 140a, which moves to the outside of the magnetic seal sleeve 170 and has high risk of leakage from the case 110, may be pushed back to and returns to the seal gap 180 by the shaft helical groove 138 and the case helical groove 228. Therefore, it is possible to reduce leakage of the MRF 140 to the outside of the case 110.

In addition, the case helical groove 228 can work as the gas liquid separator and can separate the gas from the MRF 140a during the MRF 140a is pushed to the seal gap 180. If the MRF 140a returned to the seal gap 180 contains any gas component, the gas may lower the self-sealing function of the MRF 140 in the seal gap 180. According to the embodiment, however, the case helical groove 228 and the shaft helical groove 133 may reduce the gas. Therefore, it is possible to avoid lowering of the self-sealing function.

### Third Embodiment

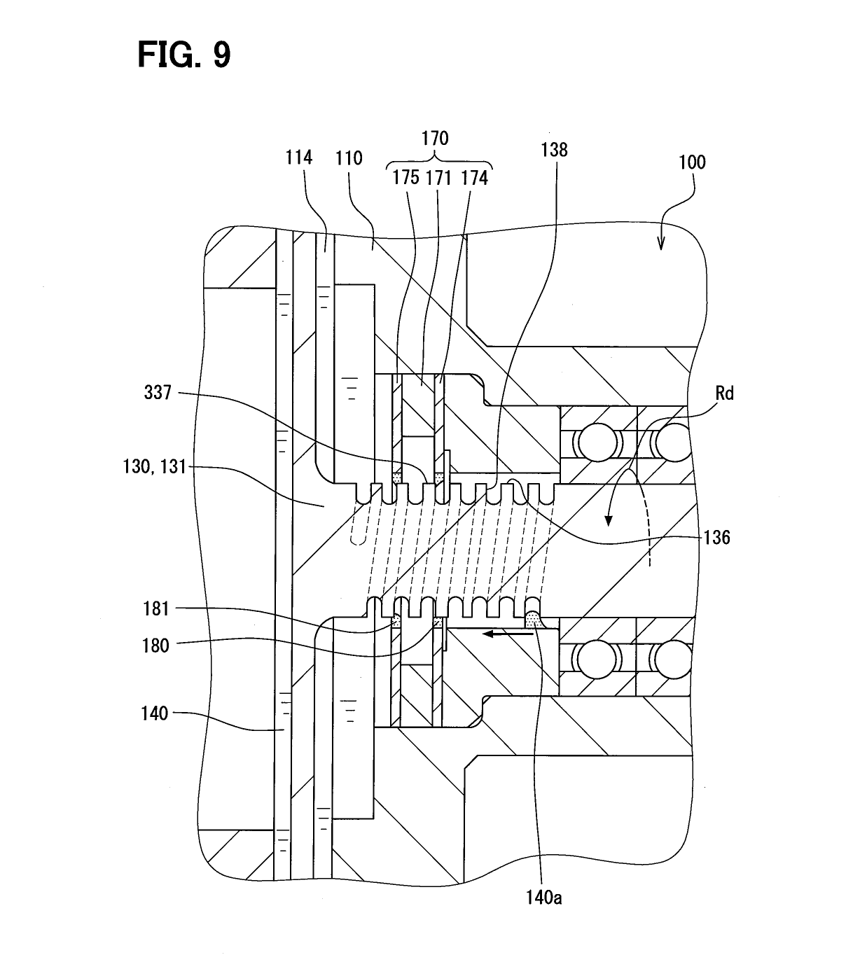

As shown in FIG. 9, this embodiment is a modification of the first embodiment. In this embodiment, an extended wall 337 is formed on the peripheral wall of the brake shaft 131. The brake shaft 131 has the extended wall 337. The extended wall 337 is extended from the opposing wall 136 to the fluid chamber 114 over the magnetic seal sleeve 170. The shaft helical groove 138 is continuously formed on both the opposing wall 136 and the extended wall 337. The extended wall 337 and the flux guide yokes 174 and 175 of the magnetic seal sleeve 170 define seal gaps 180 and 181 there between. The shaft helical groove 138 in this embodiment is continuously formed on both the opposing wall 136 and the extended wall 337. Therefore, an end of the shaft helical groove 138 on the fluid chamber 114 is located on an inside from the magnetic seal sleeve 170. In other words, the shaft helical groove 138 directly opens to the fluid chamber 114 to be sealed by the magnetic seal sleeve 170.

In this embodiment, the MRF 140a spilled to the outside of the magnetic seal sleeve 170 may be pumped toward the fluid chamber 114 by flowing in the shaft helical groove 138 by tracing the shaft helical groove 138 in the counter direction of the rotational direction Rd of the brake member 130. Since the shaft helical groove 138 extends over the magnetic seal sleeve 170, the MRF 140a may return to the inside of the magnetic seal sleeve 170. In other words, the MRF 140a may be pumped into the fluid chamber 114. Therefore, it is possible to reduce leakage of the MRF 140 to the outside of the case 110.

In addition, in this embodiment, the MRF 140a pumped to the inside of the magnetic seal sleeve 170 by following the shaft helical groove 138 is prevented from flowing out to the outside of the magnetic seal sleeve 170 by the MRF 140 caught in the seal gaps 180 and 181. Therefore, it is possible to improve the certainty of performing the function for reducing leakage of the MRF 140a to the outside of the case 110.

### Fourth Embodiment

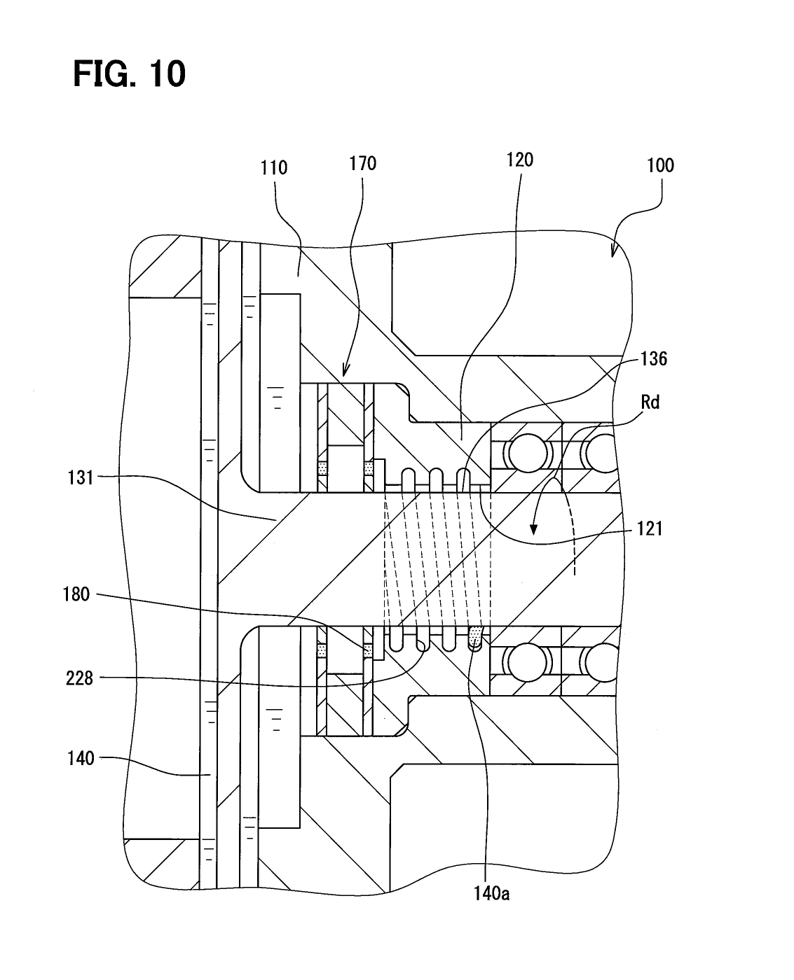

As shown in FIG. 10, this embodiment is a modification of the first embodiment. In this embodiment, the surrounding wall 121 of the nonmagnetic member 120 is formed with the case helical groove 228 that is substantially the same as that in the second embodiment. On the other hand, the shaft helical groove 138 shown in FIG. 5 is removed from the opposing wall 136.

The MRF 140a on the outside of the magnetic seal sleeve 170 may be caught by the case helical groove 228. The MRF 140a follows and traces the case helical groove 228 in the rotational direction Rd by friction on the opposing wall 136 of the brake shaft 131 which rotates in the rotational direction Rd. The case helical groove 228 is formed to be approached to the magnetic seal sleeve 170 as the case helical groove 228 is traced along the rotational direction Rd. The MRF 140a follows the case helical groove 228 in the rotational direction Rd as the brake member 130 rotates in the rotational direction Rd. As a result, the MRF 140a is pushed to and moves toward the magnetic seal sleeve 170 and again caught by the seal gap 180.

According to the embodiment, the MRF 140a, which moves to the outside of the magnetic seal sleeve 170 and has high risk of leakage from the case 110, may be pushed back to and returns to the seal gap 180 by the case helical groove 228. Therefore, it is possible to reduce leakage of the MRF 140 to the outside of the case 110.

### Fifth Embodiment

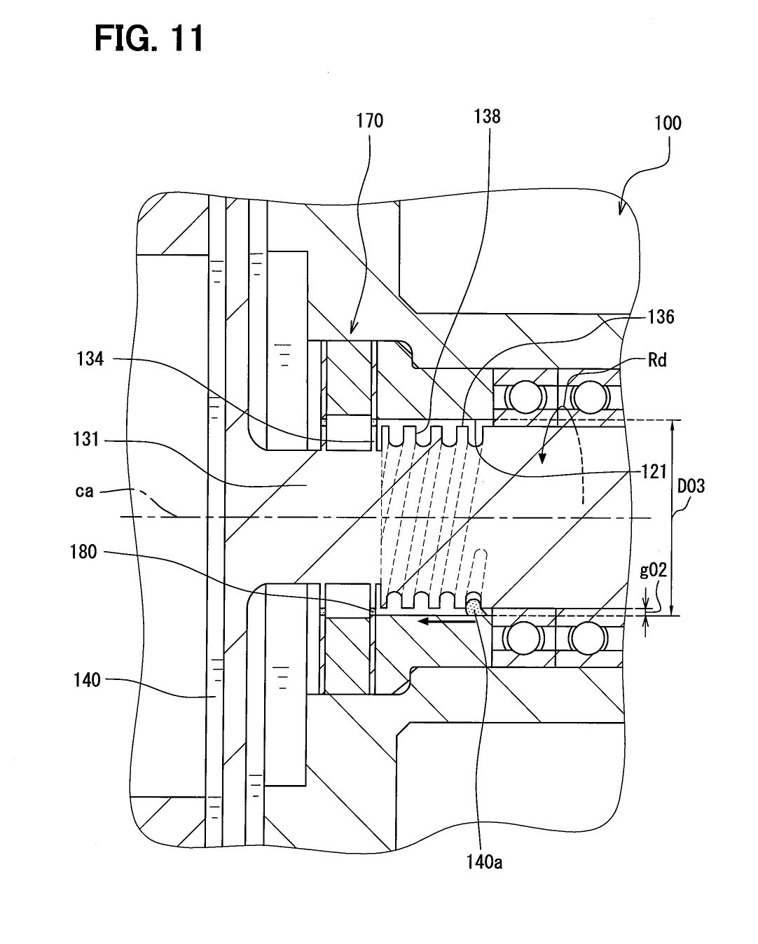

As shown in FIG. 11, this embodiment is a modification of the first embodiment. The brake member 130 has a shaft flux guide 134 which is coaxially formed with the opposing wall 136. The shaft flux guide 134 defines the seal gap 180 with the magnetic seal sleeve 170 facing in the radial direction. The opposing wall 136 has an outer diameter that is arranged equal to an outer diameter of the shaft flux guide 134. In this embodiment, both the outside diameters of the opposing wall 136 and the shaft flux guide 134 are denoted by D03.

The seal gap 180 is placed next to the gap g02 in the axial direction. Therefore, the MRF 140a, which returns close to the magnetic seal sleeve 170 along the shaft helical groove 138, can be entered into and caught by the seal gap 180 through the gap g02 without changing flowing direction.

In this embodiment, movement of the MRF 140a, which is pushed to the seal gap 180 by the shaft helical groove 138, is facilitated. The MRF may be returned easily to the seal gap 180 again. Therefore, it is possible to improve the certainty of performing the function for reducing leakage of the MRF 140 to the outside of the case 110.

In addition, the outside diameter of the opposing wall 136 is not larger than the outside diameter of the shaft flux guide 134. Therefore, the opposing wall 136 can pass the inner circumference of the shaft flux guide 134 when assembling the fluid brake device 100. It is possible to avoid complication of assembling process. Based on the above mentioned structure, by enlarging the outside diameter D03 of the opposing wall 136, a distance in the radial direction between an axis “ca” of the brake shaft 131 and the shaft helical groove 138 can be set longer. According to the above arrangement, the centrifugal force acting on the MRF 140a may be increased. Increased centrifugal force may further facilitate movement of the MRF 140a in the shaft helical groove 138. Therefore, it is possible to improve the certainty of performing the function for reducing leakage of the MRF 140 to the outside of the case 110.

### Sixth Embodiment

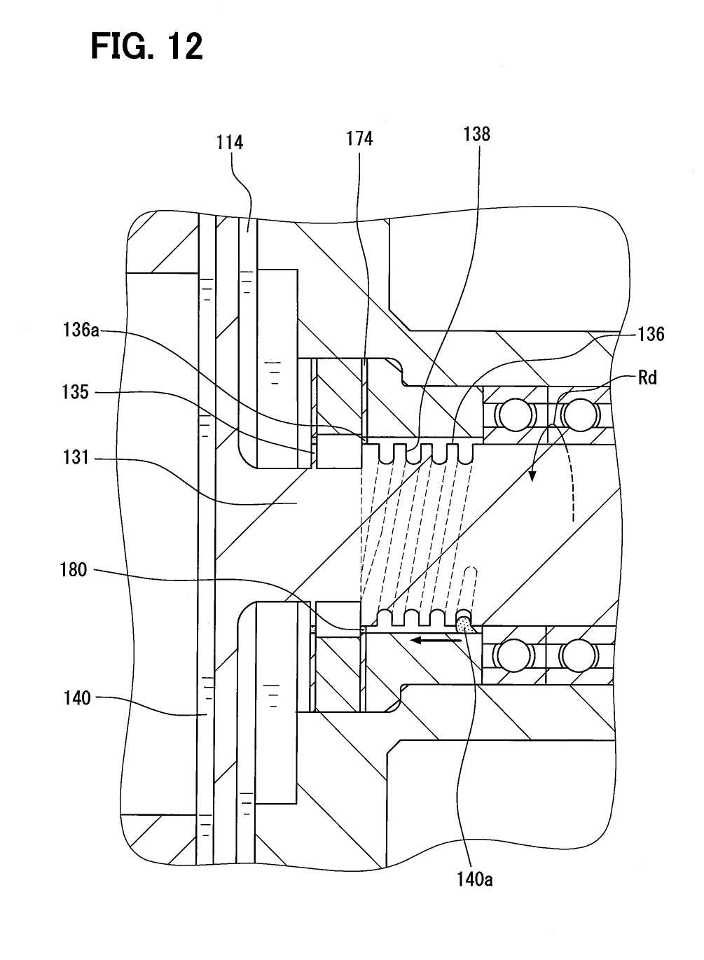

As shown in FIG. 12, the sixth embodiment is a modification of the fifth embodiment. In this embodiment, the opposing wall 136 on the brake shaft 131 is extended toward the fluid-chamber 114 side along the axial direction. The brake member 130 has a shaft flux guide 135 which is coaxially formed with the opposing wall 136. The opposing wall 136 has an outer diameter that is arranged equal to an outer diameter of the shaft flux guide 135. In addition, the opposing wall 136 has an end portion 136a on a side to the fluid chamber 114. The end portion 136a is located radial inside of the flux guide yoke 174. Therefore, the end portion 136a provides a shaft flux guide. In this arrangement, the seal gap 180, which catches the MRF 140, is formed between the end portion 136a of the brake shaft 131 and the flux guide yoke 174.

### Seventh Embodiment

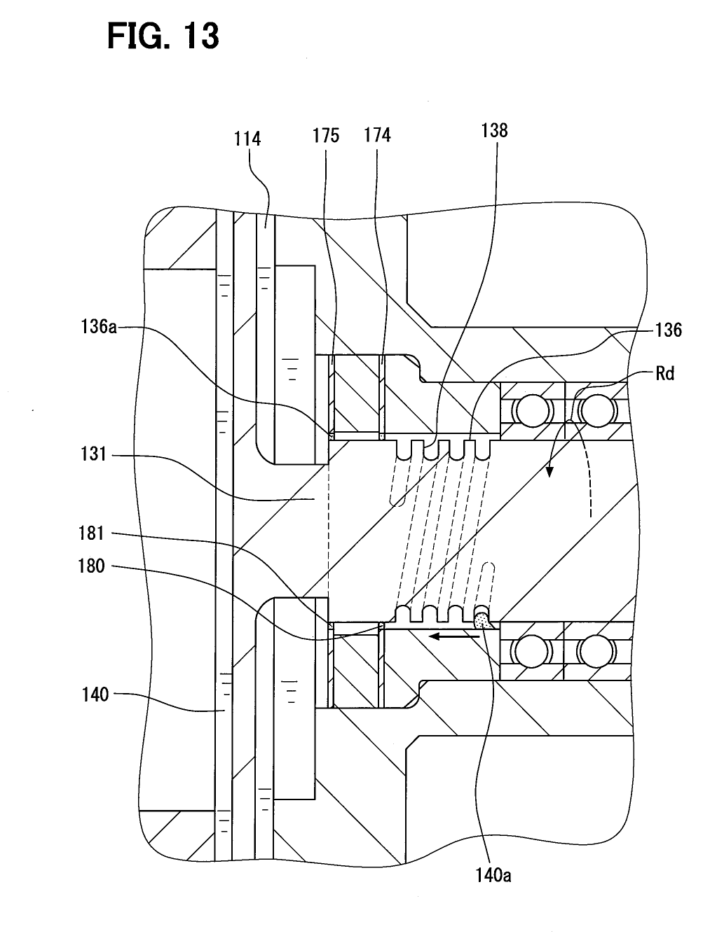

As shown in FIG. 13, the seventh embodiment is a modification of the sixth embodiment. In this embodiment, the opposing wall 136 on the brake shaft 131 is further extended toward the fluid-chamber 114 side along the axial direction. The opposing wall 136 has an end portion 136a on a side to the fluid chamber 114. The end portion 136a is located radial inside of the flux guide yoke 175. In this arrangement, the seal gap 180 is formed between an outer surface of the brake shaft 131 and the flux guide yoke 174. In addition, the seal gap 181 is formed between the end portion 136a of the brake shaft 131 and the flux guide yoke 175.

According to the sixth and seventh embodiments, the brake shaft 131 has an outer surface which defines the seal gap 180. This outer surface is continuously formed with the opposing wall 136 where the shaft helical groove 138 is formed. Therefore, movement of the MRF 140a, which is pushed to the seal gap 180 by the shaft helical groove 138, is facilitated. The MRF may be returned easily to the seal gap 180 again. Therefore, it is possible to improve the certainty of performing the function for reducing leakage of the MRF 140 to the outside of the case 110.

### Eighth Embodiment

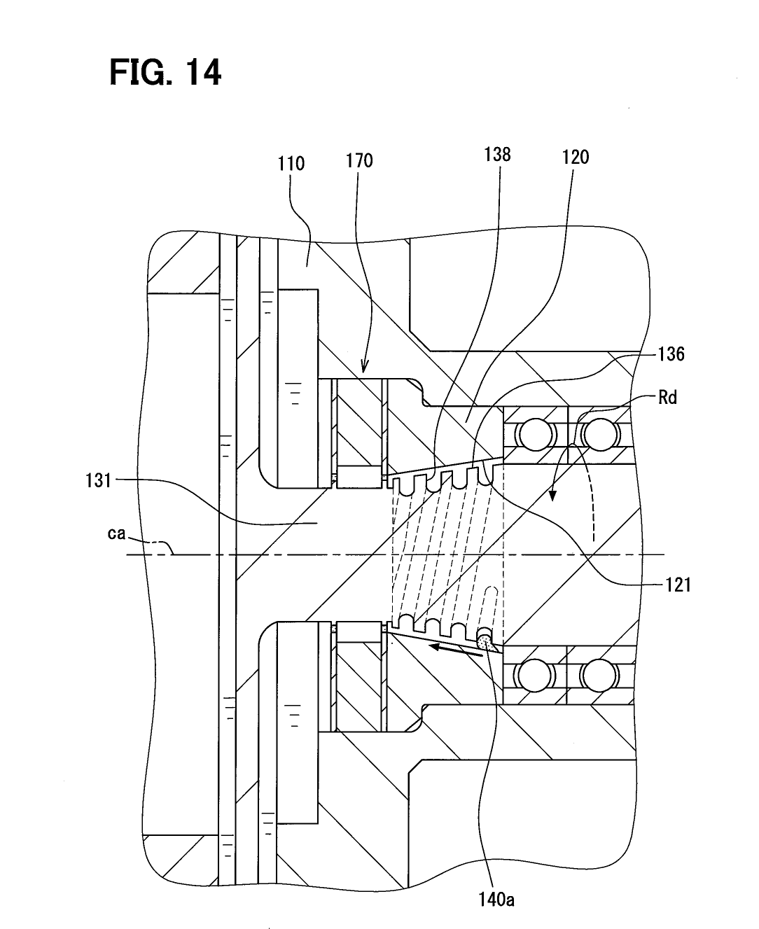

As shown in FIG. 14, the eighth embodiment is a modification of the first embodiment. In this embodiment, an inner diameter of the surrounding wall 121 of the nonmagnetic member 120 is gradually expanded as a distance of a portion of the surrounding wall 121 from the magnetic seal sleeve 170 is increased. In addition, an outer diameter of the opposing wall 136 is also expanded as a distance of a portion of the opposing wall 136 from the magnetic seal sleeve 170 is increased. Both the surrounding wall 121 and the opposing wall 136 are formed in tapered cone shapes. The surrounding wall 121 and the opposing wall 136 are formed to maintain a gap between the surrounding wall 121 and the opposing wall 136 constant. The shaft helical groove 138 is formed on the tapered cone. A radial distance from the axis “ca” of the brake shaft 131 to the shaft helical groove 138 formed on the opposing wall 136 is increased as a distance of a portion of the shaft helical groove 138 from the magnetic seal sleeve 170 is increased. As a result, a radial distance from an axis “ca” of the brake shaft 131 to the shaft helical groove 138 is increased as the shaft helical groove 138 is distanced away from the magnetic seal sleeve 170.

According to the above arrangement, the rotation of the brake shaft 131 in the rotational direction Rd may apply the centrifugal force on the MRF 140a caught by the shaft helical groove 138. The centrifugal force acting on the MRF 140a may be increased as a location of the MRF 140a is more distanced from the magnetic seal sleeve 170. In other words, the value of the centrifugal force acting on the MRF 140a is proportional to the distance of the MRF 140a from the magnetic seal sleeve 170. Therefore, the MRF 140a, which is located far from the magnetic seal sleeve 170 and has high risk of leakage from the case 110, receives strong centrifugal force. The more the MRF 140a is distanced away from the magnetic seal sleeve 170, the stronger the centrifugal force acts thereon. As a result, the MRF 140a, which is located far from the magnetic seal sleeve 170, may receives and be pushed back toward the magnetic seal sleeve 170 with a stronger thrust force by the shaft helical groove 138. Thus, it is possible to apply stronger thrust force to the MRF 140a that has high risk of leakage. It is possible to reduce the leakage of the MRF 140a to the outside of the case 110.

### Ninth Embodiment

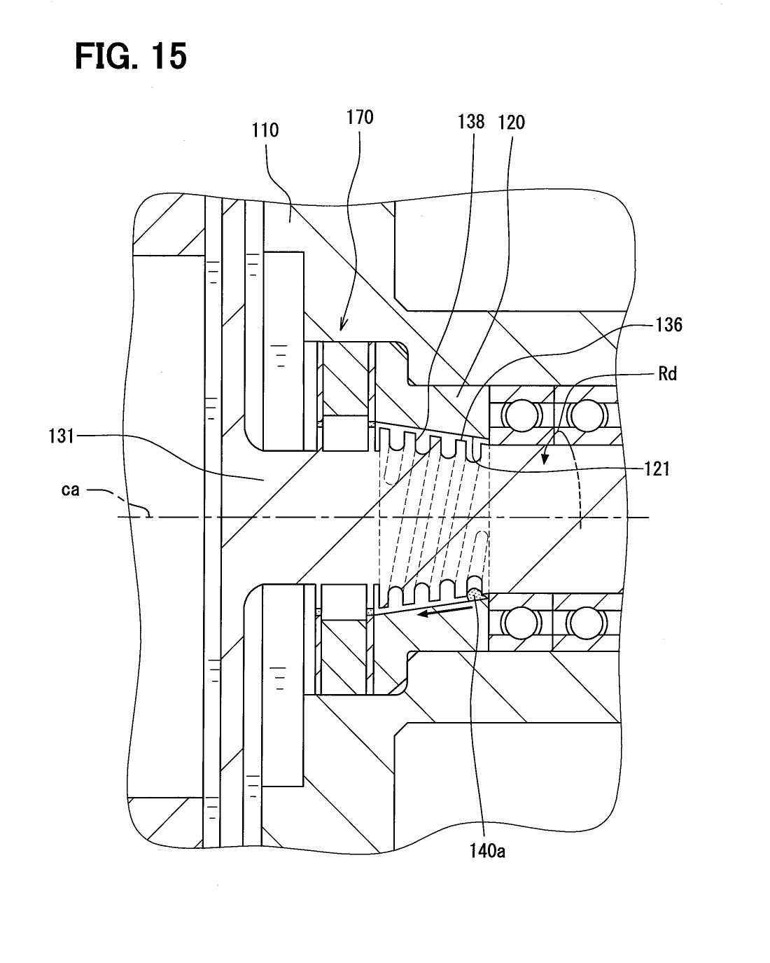

As shown in FIG. 15, the ninth embodiment is a modification of the eighth embodiment. In this embodiment, an inner diameter of the surrounding wall 121 of the nonmagnetic member 120 is gradually decreased as a distance of a portion of the surrounding wall 121 from the magnetic seal sleeve 170 is increased. In addition, an outer diameter of the opposing wall 136 is also decreased as a distance of a portion of the opposing wall 136 from the magnetic seal sleeve 170 is increased. Both the surrounding wall 121 and the opposing wall 136 are formed in tapered cone shapes. The surrounding wall 121 and the opposing wall 136 are formed to maintain a gap between the surrounding wall 121 and the opposing wall 136 constant. The shaft helical groove 138 is formed on the tapered cone. A radial distance from the axis “ca” of the brake shaft 131 to the shaft helical groove 138 formed on the opposing wall 136 is decreased as a distance of a portion of the shaft helical groove 138 from the magnetic seal sleeve 170 is increased. As a result, a radial distance from an axis “ca” of the brake shaft 131 to the shaft helical groove 138 is decreased as the shaft helical groove 138 is distanced away from the magnetic seal sleeve 170.

According to the above arrangement, the rotation of the brake shaft 131 in the rotational direction Rd may apply the centrifugal force on the MRF 140a caught by the shaft helical groove 138. The centrifugal force acting on the MRF 140a may be increased as a location of the MRF 140a is closer to the magnetic seal sleeve 170. In other words, the value of the centrifugal force acting on the MRF 140a is inversely proportional to the distance of the MRF 140a from the magnetic seal sleeve 170. Therefore, the MRF 140a, which is located close to the magnetic seal sleeve 170, receives strong centrifugal force. The closer the MRF 140a is located to the magnetic seal sleeve 170, the stronger the centrifugal force acts thereon. As a result, the MRF 140a, which is located close to the magnetic seal sleeve 170, may receives and be pushed back toward the magnetic seal sleeve 170 with a stronger thrust force by the shaft helical groove 138. By the above, movement of the MRF 140a which is pushed back to the magnetic seal sleeve 170 is facilitated. Therefore, the MRF 140a returns easily to the magnetic seal sleeve 170 along with the shaft helical groove 138. Therefore, it is possible to improve the certainty of performing the function for reducing leakage of the MRF 140a to the outside of the case 110.

### Other Embodiments

Although the present disclosure is described based on the illustrated embodiments, the present disclosure should not be limited to such embodiments illustrated, may be implemented in other ways and be applied to any combinations and modifications without departing from the scope of the disclosure.

In the embodiments, the axial gap g01 between the end face 121a of the surrounding wall 121 and the end face 134a of the shaft flux guide 134 is set wider than the radial gap g02 between the opposing wall 136 and the surrounding wall 121. However, sizes of the gaps g01 and g02 may be suitably changed, as long as it is possible to flow the MRF 140a therethrough. For example, the gap g01 may be set narrower than the gap g02, or may be set the same as the gap g02. A gap g_sl of the seal gap shown in FIG. 5 may be set wider than both the gaps g01 and g02, or may be set narrower than both the gaps g01 and g02. The gap g_sl of the seal gap may be set the same as both the gaps g01 and g02.

In the embodiments, in order to restrict the magnetic flux passing trough the surrounding wall 121, the nonmagnetic member 120 is made of copper alloy which is a nonmagnetic material. However, the nonmagnetic member forming the surrounding wall may be made by other nonmagnetic materials, such as stainless steel, resin materials, etc. The surrounding wall may be made of materials which can restrict the magnetic flux. For example, the surrounding wall may be made of weak magnetic materials, such as aluminum.

In the embodiments, the shaft helical groove 138 and the case helical groove 228 are formed with a constant interval between axially adjacent portions. In other words, the shaft helical groove 138 and the case helical groove 228 have a constant helical pitch. However, the helical pitch of the helical grooves may not be constant. For example, the shaft helical groove and/or the case helical groove may be formed with a variable pitch which is increased as the groove is more distanced from the magnetic seal sleeve. Contrary, the shaft helical groove and/or the case helical groove may be formed with a variable pitch which is decreased as the groove is more distanced from the magnetic seal sleeve. The cross sectional shape of the shaft helical groove and the case helical groove in the longitudinal cross section is not limited to the cross sectional shape in the embodiments. The cross sectional shape of the helical grooves may be suitably changed into any forms. For example, the cross sectional shape of the helical grooves may be modified to facilitate movement of the MRF 140a.

In the embodiments, the shaft helical groove 138 and the case helical groove 228 are formed to circle around two or more times. However, the length of the shaft helical groove and the case helical groove may be changed suitably. For example, the shaft helical groove and the case helical groove may have a length less than a length corresponding to a one round of the opposing wall and the surrounding wall. The shaft helical groove and the case helical groove may be divided into a plurality of sections. The opposing wall may be formed with a plurality of shaft helical grooves. The surrounding wall may be formed with a plurality of case helical grooves.

In the embodiments, the surrounding wall 121 is coaxially disposed with the magnetic seal sleeve 170. The surrounding wall 121 has an inner diameter d02 equal to or smaller than an inner diameter d01 of the flux guide yoke 174, i.e., the magnetic seal sleeve 170. However, relations of the size of the inner diameter of the surrounding wall and the inner diameter of the flux guide yoke may be changed suitably. In the embodiments, in order to reduce complication of an assembly of the fluid brake device 100, the outer diameter of the opposing wall portion 136 is formed equal to the outer diameter D03 of the shaft flux guide as shown in FIG. 11. However, if it is necessary to apply higher pumping force to the MRF, the outer diameter of an opposing wall may be formed larger than the outer diameter of the shaft flux guide to increase centrifugal force on the MRF 140a. In each embodiment, it is possible to bring and combine the configurations disclosed in the other embodiments.

Alternatively, any form of phase adjusting mechanism 300, which can adjust an engine phase according to an braking torque inputted to the brake member 130, may be employed. Although the present invention is applied to an intake valve operating apparatus in the embodiments, the present invention may be applied to an apparatus for operating an exhaust valve or an apparatus for operating both the intake and the exhaust valves. In addition, the fluid brake device disclosed may be applied to apparatus other than the variable valve timing apparatus.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fluid brake device comprising:
a case defining a fluid chamber inside;
magneto-rheological fluid kept in the fluid chamber, the magneto-rheological fluid having a viscosity variable in accordance with magnetic flux passing through;
a control device which carries out variable control of the viscosity of the magneto-rheological fluid by varying the magnetic flux;
a brake member rotatably supported on the case, the brake member having a brake shaft penetrating the case and a rotor being supported to come into contact with the magneto-rheological fluid so that the rotor receives a braking torque according to the viscosity of the magneto-rheological fluid;
a magnetic seal disposed on the case, the magnetic seal being formed in an annular shape to surround the brake shaft, and defining a seal gap where a magnetic flux is supplied to hold the magneto-rheological fluid in the fluid chamber; and
an axially pumping element disposed on an axial outside of the magnetic seal, which is an opposite side of the magnetic seal from the fluid chamber in an axial direction, the axially pumping element providing a helical path to push the magneto-rheological fluid back to the seal gap as the brake shaft rotates.

2. The fluid brake device claimed in claim 1, wherein
the seal gap has an opening which opens toward the axial outside and has a portion located radial outer side than the axially pumping element.

3. The fluid brake device claimed in claim 2, wherein
the axially pumping element being formed on at least one of a part of the case and a part of the brake shaft which are radially face each other.

4. The fluid brake device claimed in claim 1, wherein
the magnetic seal has a magnetic seal sleeve which is formed in a shape to surround the brake shaft along a rotational direction to define the seal gap with the brake shaft, and generates the magnetic flux guided to pass through the seal gap, and wherein
the case has a surrounding wall surrounding the brake shaft along the rotational direction at the axial outside of the magnetic seal, and wherein
the brake shaft provides an opposing wall radially opposite to the surrounding wall and a shaft helical groove formed on the opposing wall, the shaft helical groove being formed in a helical shape inclined to be more distanced from the magnetic seal sleeve as the shaft helical groove is traced along the rotational direction of the brake member.

5. The fluid brake device claimed in claim 4, wherein
the surrounding wall is coaxially disposed with the magnetic seal sleeve, and wherein
the surrounding wall has an inner diameter equal to or smaller than an inner diameter of the magnetic seal sleeve.

6. The fluid brake device claimed in claim 4, wherein
the surrounding wall restricts the magnetic flux generated and guided by the magnetic seal sleeve.

7. The fluid brake device claimed in claim 4, wherein
the case has a case helical groove formed on the surrounding wall, the case helical groove being formed in a helical shape inclined to be more approached to the magnetic seal sleeve as the case helical groove is traced along the rotational direction of the brake member.

8. The fluid brake device claimed in claim 4, wherein
the brake shaft has an extended wall which is extended from the opposing wall to the fluid chamber over the magnetic seal sleeve, and wherein
the shaft helical groove is continuously formed on both the opposing wall and the extended wall.

9. The fluid brake device claimed in claim 4, wherein
the brake member has a shaft flux guide projecting from the brake shaft in a radial outside direction, the shaft flux guide defining the seal gap with the magnetic seal sleeve at a fluid chamber side of the end face of the surrounding wall, and wherein
the shaft flux guide and the end face of the surrounding wall defines an axial gap which is wider than a radial gap between the opposing wall and the surrounding wall.

10. The fluid brake device claimed in claim 4, wherein
the brake member has a shaft flux guide which is coaxially formed with the opposing wall and defines the seal gap with the magnetic seal sleeve facing in the radial direction, and wherein
the opposing wall has an outer diameter that is arranged equal to an outer diameter of the shaft flux guide.

11. The fluid brake device claimed in claim 4, wherein
a radial distance from an axis of the brake shaft to the shaft helical groove is increased as the shaft helical groove is distanced away from the magnetic seal sleeve.

12. The fluid brake device claimed in claim 4, wherein
a radial distance from an axis of the brake shaft to the shaft helical groove is decreased as the shaft helical groove is distanced away from the magnetic seal sleeve.

13. The fluid brake device claimed in claim 1, wherein
the magnetic seal has a magnetic seal sleeve which is formed in a shape to surround the brake shaft along a rotational direction to define the seal gap with the brake shaft, and generates the magnetic flux guided to pass through the seal gap, and wherein
the case has a surrounding wall surrounding the brake shaft along the rotational direction at the axial outside of the magnetic seal, and wherein
the surrounding wall provides a case helical groove formed on the surrounding wall, the case helical groove being formed in a helical shape inclined to be approached to the magnetic seal sleeve as the case helical groove is traced along the rotational direction of the brake member.

14. A variable valve timing device for adjusting a valve timing of a valve being opened/closed by a camshaft which is driven by a torque transmitted from a crankshaft of an internal combustion engine, the variable valve timing device comprising:
the fluid brake device claimed in claim 1; and
a phase adjusting mechanism engaged with the brake shaft at an outside of the case for adjusting an relative phase between the crankshaft and the camshaft according to the braking torque acting on the brake member.
